(19) United States
(12) Patent Application Publication
(10) Pub. No.: US 2025/0060930 A1
(43) Pub. Date: Feb. 20, 2025

(54) A COLLABORATIVE CONTENT SYSTEM

(71) Applicant: FlatFrog Laboratories AB, Lund (SE)

(72) Inventors: Jakob Berglund, Lund (SE); Kevin Furmanski, Limhamn (SE)

(21) Appl. No.: 18/861,491

(22) PCT Filed: Apr. 18, 2023
(86) PCT No.: PCT/SE2023/050352

§ 371 Date: Oct. 29, 2024

(30) Foreign Application Priority Data
May 4, 2022 (SE) 2230132-9
Jan. 30, 2023 (SE) 2330055-1

(51) Int. Cl. G06F 3/14

(52) U.S. Cl. CPC G06F 3/1454

(57) ABSTRACT

A collaborative content system, comprising: a local device running a video conferencing application, a local interactive system running an instance of a video conferencing application, a video conferencing backend system configured to: provide a video conferencing session to video conferencing application, receive a request for a whiteboard application session from a video conferencing application, provide the request for the whiteboard application session to collaborative application backend system, the collaborative application backend system configured to: generate the whiteboard application session, provide the whiteboard application session to the video conferencing backend system, provide the whiteboard application session to the whiteboard application for real-time collaborative editing by the user.

### TECHNICAL FIELD

The present disclosure relates to a collaborative content system that enables users to collaborate on content from different devices. Examples of the collaborative content include Google Docs, Microsoft Word Online, digital whiteboarding, etc.

### BACKGROUND OF THE INVENTION

The traditional way of collaborating on content is for each user to have a copy of the content on their local device, and then use a video conferencing application to share their screen and work on the content together. However, this requires each user to have a copy of the content, which can be difficult to keep in sync, and can lead to versioning issues. A solution to this problem is the use of collaborative content systems, such as Google Docs, Microsoft Word Online, digital whiteboarding applications, etc, to enable users to work on content together in real time. However, these collaborative content systems are not well suited for use with video conferencing applications in a meeting room environment, as it becomes difficult to ensure that all the interactive devices in the room are all correctly connected to the relevant session of the collaborative content system.

Therefore, the problem to be solved is that of enabling multiple interactive devices in a meeting room to be connected to the same collaborative session of a collaborative content system.

### SUMMARY OF THE INVENTION

An aspect of the disclosure provides a collaborative content system, comprising: a local device, a local interactive system, a remote collaborative application backend system configured to: receive a request for a whiteboard application session from a user via the local device, deliver the whiteboard application session to the local device, automatically deliver the whiteboard application session to the local interactive system for real-time collaborative editing by the user.

Another aspect of the disclosure provides a collaborative content system, comprising: a local device running a video conferencing application, a local interactive system running an instance of a video conferencing application, a video conferencing backend system configured to: provide a video conferencing session to video conferencing application, receive a request for a whiteboard application session from a video conferencing application, provide the request for the whiteboard application session to collaborative application backend system, the collaborative application backend system configured to: generate the whiteboard application session, provide the whiteboard application session to the video conferencing backend system, provide the whiteboard application session to the whiteboard application for real-time collaborative editing by the user.

Another aspect of the disclosure provides a method, comprising: running a video conferencing application on a local device, running a whiteboard application on a local interactive system, operating a video conferencing backend system to: provide a video conferencing session to video conferencing application, receive a request for a whiteboard application session from a video conferencing application, provide the request for the whiteboard application session to collaborative application backend system, operating a collaborative application backend system configured to: generate the whiteboard application session, provide the whiteboard application session to the video conferencing backend system, provide the whiteboard application session to the whiteboard application for real-time collaborative editing by the user.

### BRIEF DESCRIPTION OF DRAWINGS

These and other aspects, features, and advantages of which examples of the disclosure are capable of will be apparent and elucidated from the following description of examples of the present invention, reference being made to the accompanying drawings, in which;

FIG. 1 is an illustration of a meeting room;

FIG. 2 is a network diagram of an embodiment of the collaborative content system;

FIG. 3 is a sequence diagram of an embodiment of the collaborative content system;

FIG. 4 is a sequence diagram of another embodiment of the collaborative content system.

FIG. 5 is a sequence diagram of another embodiment of the collaborative content system.

### DETAILED DESCRIPTION OF EXAMPLE EMBODIMENTS

Embodiments of the disclosure will now be described more fully with reference to the accompanying drawings, in which some, but not all, embodiments of the invention are shown. The disclosure may be embodied in many different forms and should not be construed as limited to the embodiments set forth herein. Throughout the description, the same reference numerals are used to identify corresponding elements.

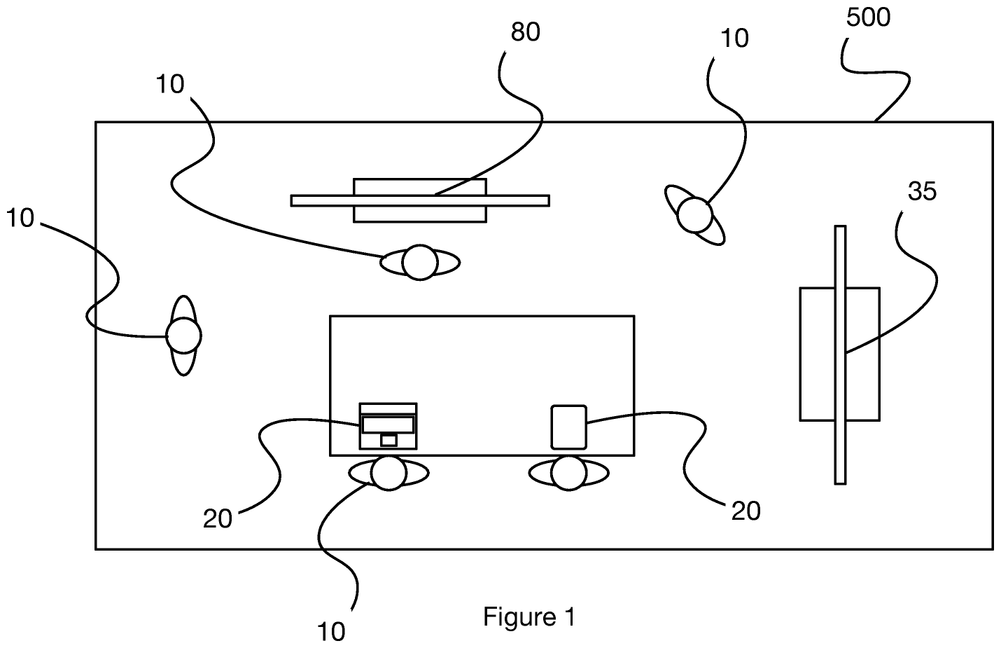

A first embodiment shown in FIG. 1 is a room 200 in which a collaborative content system 100 is operated by one or more users 10. In one embodiment, the room 200 comprises multiple users 10, a local device 20, a video conferencing application 25 operating on local device 20 (not shown), a local display 35, and a video conferencing backend system 50.

The user 10 may be a member of a group of users, such as a team of workers in an organisation, a class of students in a school, or the like. The user 10 may be an individual user. The user 10 may interact with several devices at the same time, including a local device 20 and a local interactive system 80.

The local device 20 may comprise a personal computer, a laptop computer, a tablet computer, a smartphone, a set-top box, a game console, or any other type of computing device. The local device 20 may comprise a display, such as a monitor, a television, a projector, or the like. The local device 20 may comprise an input device, such as a keyboard, a mouse, a touchpad, a touch screen, a microphone, a camera, or the like. The local device 20 may comprise a network interface, such as a wired Ethernet interface, a wireless Wi-Fi interface, a cellular data interface, or the like. The local device 20 is configured to run video conferencing application 25 and may also be configured to run whiteboard application 85.

A local display 35 may comprise a display, a camera, a speaker, and a microphone. The local display 35 may be a touch-screen device. The camera may be a high-definition camera, such as a 1080p camera. The display, camera, speaker, and microphone may be integrated into a single device, such as a tablet device, or may be separate devices. The screen size for the local display 35 may be between 2 inches and 200 inches. The local display 35 may run a video conferencing application 25 and display a video feed from the camera. The local display 35 may also display a video feed from a remote video conferencing display (not shown). The local display 35 may display a video feed from the camera and the remote video conferencing display simultaneously. The local display 35 may display a video feed from the camera in a first portion of the display and the video feed from the remote video conferencing display in a second portion of the display. The local display 35 may also display a whiteboard application session 40 in a third portion of the display. The whiteboard application session 40 may be displayed in a separate window or in a separate portion of the display. The local display 35 may further comprise a processor, memory, and a network interface. The processor may be a microprocessor, such as an Intel® processor. Interface may be a wired or wireless network interface.

The video conferencing application 25 may comprise any type of video conferencing software application, such as Zoom, Skype, Google Meets, Microsoft Teams, or the like. The video conferencing application 25 may be running on local device 20. The video conferencing application 25 may be downloaded and installed on the local device 20. The video conferencing application 25 may be a web-based application that is accessed via a web browser.

The video conferencing backend system 50 may comprise one or more servers that provide video conferencing services to the video conferencing application 25. The video conferencing backend system 50 may be operated by a video conferencing service provider, such as Zoom, Skype, Google Meets, Microsoft Teams, or the like.

The room credentials 70 may comprise a room identifier and a room password. The room identifier may be a unique identifier for the room. The room identifier may be a random string of characters. The room identifier may be generated by the video conferencing backend system 50. The room password may be a secret password known only to authorised users of the room. The room password may be generated by the video conferencing backend system 50. Room credentials 70 may include information about other devices in the room, including local interactive system 80. The information about other devices in the room allows the devices in the room to be targeted with services, e.g. whiteboard application session 40.

A video conferencing session 30 is generated by the video conferencing backend system 50 and provided to video conferencing application 25 via a network, e.g. the internet. The video conferencing session 30 may comprise a plurality of users, including the user 10. The video conferencing session 30 may be provided to a plurality of devices, including the local device 20 and local display 35.

The collaborative application backend system 60 may comprise one or more servers that provide a collaborative real-time application, such as Google Docs, Microsoft Word Online, etc, to a plurality of network connected users. In this disclosure, the collaborative application backend system 60 is described as providing a whiteboard application session 40 for real-time collaborative interaction by a plurality of users, but it may be understood that the collaborative content provided could be text documents, spreadsheets, or other real-time collaborative content. The collaborative application backend system 60 may be configured to provide a whiteboard application session 40 to one or more whiteboard applications 85 running on devices used by users, including at least one of local device 20, local display 35, and local interactive system 80. The collaborative application backend system 60 may be operated by a collaborative services provider, such as Google, Microsoft, FlatFrog Laboratories, or the like.

A whiteboard application session 40 may be provided to users for real-time collaborative interaction via a whiteboard application 85. Each user may interact with the whiteboard application 85 by inputting text, drawing, or other input. The digital whiteboard may comprise a plurality of digital whiteboard pages, each of which may be shared by the plurality of users. The digital whiteboard may be associated with a plurality of digital whiteboard sessions, each of which may be used by the plurality of users to interact with. The whiteboard application session 40 comprises the session data for all of the interactions from the users, as well as at least a unique session ID and a unique user ID. The session data may be saved to a file or database on a collaborative application backend system 60. The session data may be saved to a file or database on a client device. The session data may be saved to a file or database on a third-party server. The session data may be saved to a file or database on a cloud-based server.

A local interactive system 80 is a large screen touch display suitable for running a digital whiteboard application. The local interactive system 80 may be a touch screen display device, such as an LCD display, a plasma display, or a projector with an integrated touch screen. The local interactive system 80 may be integrated with a computer or may be a stand-alone device. The local interactive system 80 may be integrated with a digital whiteboard application or may be a stand-alone device. Touch interaction with the local interactive system 80 may be performed using a finger, a stylus, or other pointing device. The local interactive system 80 may be connected to a network, such as a local area network (LAN) or a wide area network (WAN), or may be connected to a computer. The local interactive system 80 may be connected to a computer via a wired connection, such as a USB connection, or may be connected to a computer via a wireless connection, such as a Bluetooth connection. The local interactive system 80 may be connected to a network via a wired connection, such as an Ethernet connection, or may be connected to a network via a wireless connection, such as a Wi-Fi connection. The local interactive system 80 is configured to run whiteboard application 85 and may also be configured to run video conferencing application 25.

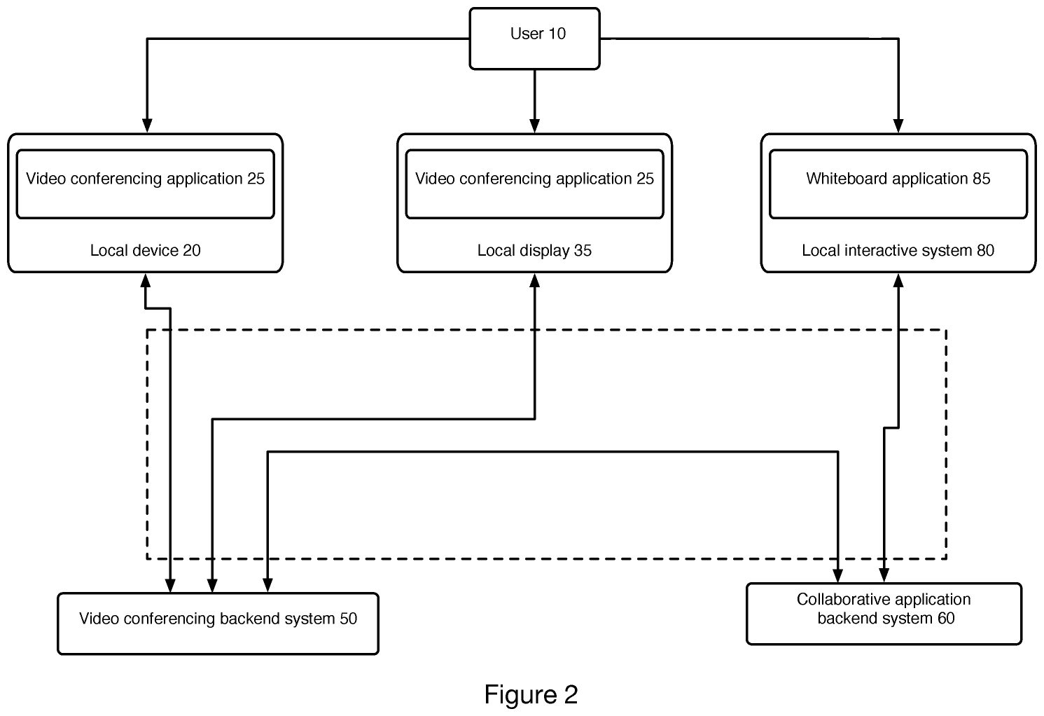

FIG. 2 shows a network diagram of an embodiment of collaborative content system 100. User 10 interacts with Video conferencing applications 25 running on Local device 20 to request and/or local display 35. Video conferencing applications 25 are connected to Video conferencing backend system 50 via a network, such as the internet. Video conferencing backend system 50 may connect with collaborative application backend system 60 to request whiteboard application sessions 40. Collaborative application backend system 60 is connected to Whiteboard application 85 running on Local interactive system 80. Local interactive system 80 can be operated by user 10.

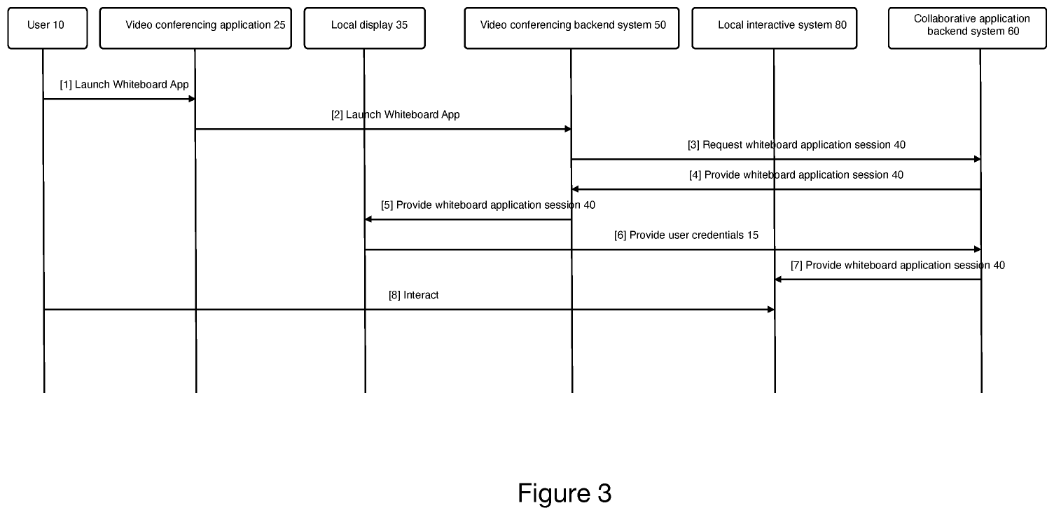

An embodiment of the disclosure shown in FIG. 3 provides a method for initiating a whiteboard application session 40 from a local device 20 and having the whiteboard application session 40 provided to the video conferencing session 30 as well as to local interactive system 80. This has the advantage of enabling a user 10 to seamlessly interact with the whiteboard application session 40 via the local interactive system 80 without having to operate the local interactive system 80 to try and join whiteboard application session 40, including identifying the right session ID, providing user credentials, etc:
1. A user 10 interacts with a local device 20 operating a video conferencing application 25. The video conferencing application 25 is connected to a video conferencing session 30. The video conferencing session 30 is also displayed on local display 35.
2. The user 10 requests a whiteboard application session 40 via the video conferencing application 25.
3. The video conferencing application 25 requests the whiteboard application session 40 from video conferencing backend system 50.
4. The video conferencing backend system 50 requests the whiteboard application session 40 from the collaborative application backend system 60.
5. The collaborative application backend system 60 provides the whiteboard application session 40 to video conferencing backend system 50.
6. The video conferencing backend system 50 provides the whiteboard application session 40 to video conferencing session 30. Video conferencing session 30 is displayed on local device 20 and local display 35.
7. Local display 35 provides room credentials 70 to collaborative application backend system 60. Local interactive system 80 may be identified using room credentials 70.
8. Collaborative application backend system 60 provides the whiteboard application session 40 to local interactive system 80.
9. User 10 interacts with the whiteboard application session 40 via local interactive system 80.

An alternative embodiment to FIG. 3 is described below:
1. A user 10 interacts with a local device 20 operating a video conferencing application 25. The video conferencing application 25 is connected to a video conferencing session 30. The video conferencing session 30 is also displayed on local display 35 via a logical user 11, that also attends video conferencing session 30. Logical user 11 may comprise a video conferencing session 30 user operated from local display 35.
2. The user 10 requests a whiteboard application session 40 via the video conferencing application 25.
3. The video conferencing application 25 requests the whiteboard application session 40 from video conferencing backend system 50.
4. The video conferencing backend system 50 requests the whiteboard application session 40 from the collaborative application backend system 60.
5. The collaborative application backend system 60 provides the whiteboard application session 40 to video conferencing backend system 50.
6. The video conferencing backend system 50 provides the whiteboard application session 40 to video conferencing session 30. Video conferencing session 30 is displayed on local device 20.
6a. The collaborative application backend system 60 sends a request to video conferencing backend system 50 to add a meeting bot 75 into the meeting. The meeting bot 75 receives updates from the video conferencing backend system 50 whenever a user 10 joins or leaves the meeting.
6b. When the logical user 11 associated with the local interactive system 80 is recognized by the meeting bot 75, the meeting bot 75 will request the collaborative application backend system 60 to open the whiteboard application session 40 on the local interactive system 80. The logical user 11 may be associated with local interactive system 80 because both local display 35 and local interactive system 80 are known to be in the same room. This association may be recorded in a separate database.
7. User 10 interacts with the whiteboard application session 40 via local interactive system 80.

Meeting bot 75 may be an automated bot that can join video conferencing sessions as a user and perform automated tasks, including the tasks described above. In the above example, meeting bot 75 may query an external database and provide instructions to servers or systems external to whiteboard application session 40.

Logical user 11 may for example be a user of a video conferencing session that represents a digital device, such as local display 35, instead of a user. In one example, logical user 11 can be invited to a video conferencing session to automatically share the contents of the video conferencing session to the local display 35.

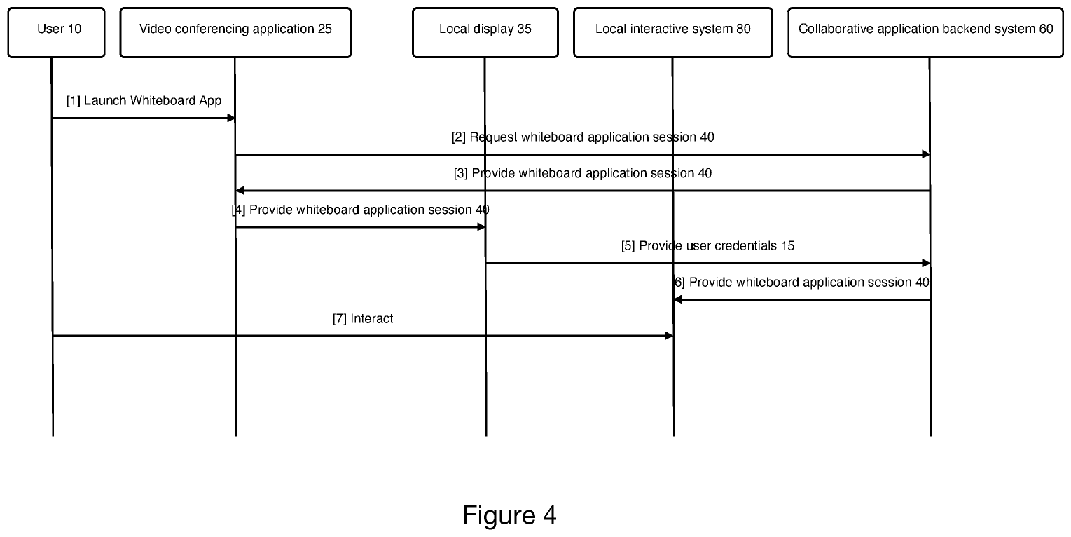

An embodiment of the disclosure shown in FIG. 4 provides an alternative method from the embodiment shown in FIG. 3:
1. A user 10 interacts with a local device 20 operating a video conferencing application 25. The video conferencing application 25 is connected to a video conferencing session 30.

The video conferencing session 30 is also displayed on local display 35.
2. The user 10 requests a whiteboard application session 40 via the video conferencing application 25.
3. The video conferencing application 25 requests the whiteboard application session 40 from collaborative application backend system 60.
4. The collaborative application backend system 60 provides the whiteboard application session 40 to video conferencing application 25.
5. The video conferencing application 25 provides the whiteboard application session 40 to video conferencing backend system 50. Video conferencing backend system 50 provides the Whiteboard application session 40 to local display 35.
6. Local display 35 provides room credentials 70 to collaborative application backend system 60. Local interactive system 80 may be identified using room credentials 70.
7. Collaborative application backend system 60 provides the whiteboard application session 40 to local interactive system 80.
8. User 10 interacts with the whiteboard application session 40 via local interactive system 80.

An alternative embodiment to FIG. 4 is described below:
1. A user 10 interacts with a local device 20 operating a video conferencing application 25. The video conferencing application 25 is connected to a video conferencing session 30. The video conferencing session 30 is also displayed on local display 35 via a logical user 11, that also attends video conferencing session 30. Logical user 11 may comprise a video conferencing session 30 user operated from local display 35.
2. The user 10 requests a whiteboard application session 40 via the video conferencing application 25.
3. The video conferencing application 25 requests the whiteboard application session 40 from collaborative application backend system 60.
4. The collaborative application backend system 60 provides the whiteboard application session 40 to video conferencing application 25.
5. The video conferencing application 25 provides the whiteboard application session 40 to video conferencing backend system 50.
5a. The collaborative application backend system 60 sends a request to video conferencing backend system 50 to add a bot into the meeting. The meeting bot receives updates from the video conferencing backend system 50 whenever a user 10 joins or leaves the meeting.
5b. When the logical user 11 pointing to the local interactive system 80 is recognized by the meeting bot 75, the meeting bot 75 will request the collaborative application backend system 60 to open the whiteboard application session 40 on the local interactive system 80. The logical user 11 may be associated with local interactive system 80 because both local display 35 and local interactive system 80 are known to be in the same room. This association may be recorded in a separate database.
6. Collaborative application backend system 60 provides the whiteboard application session 40 to local interactive system 80.
7. User 10 interacts with the whiteboard application session 40 via local interactive system 80.

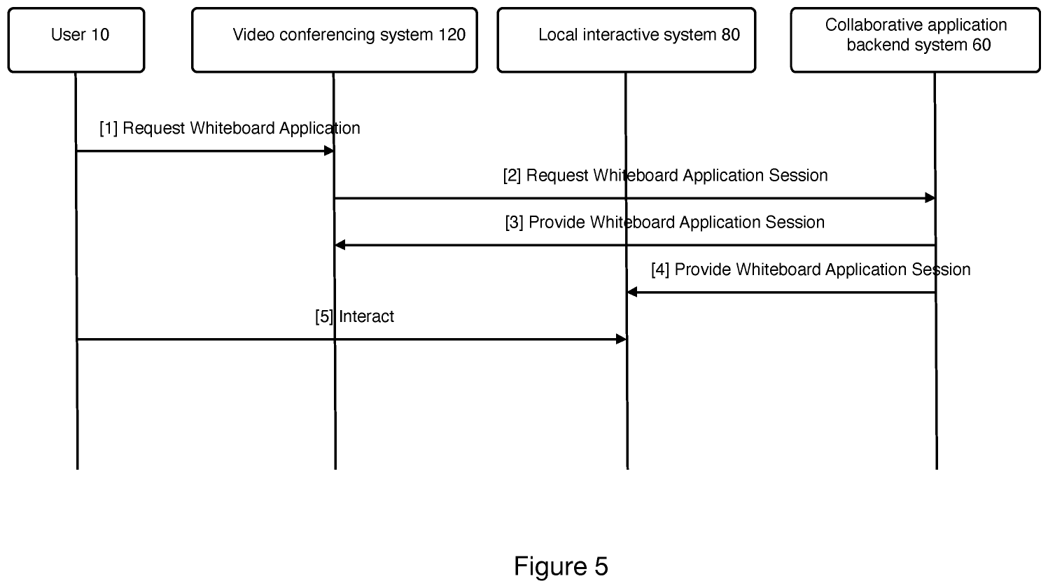

An embodiment of the disclosure shown in FIG. 5 provides an alternative method from the embodiment shown in FIGS. 3 and 4:
1. A user 10 interacts with a video conferencing system 120 to request a whiteboard application session 40.
2. The video conferencing system 120 requests the whiteboard application session 40 from Collaborative application backend system 60.
3. The collaborative application backend system 60 provides the whiteboard application session 40 to video conferencing system 120.
4. The video conferencing system 120 provides the whiteboard application session 40 to local interactive system 80.
5. User 10 interacts with the whiteboard application session 40 via local interactive system 80.

The present invention has been described above with reference to specific embodiments. However, other embodiments than the above described are equally possible within the scope of the invention. Different method steps than those described above may be provided within the scope of the invention. The different features and steps of the invention may be combined in other combinations than those described. The scope of the invention is only limited by the appended patent claims.

1. A collaborative content system, comprising:
a local device,
a local interactive system,
a remote collaborative application backend system configured to:
receive a request for a whiteboard application session from a user via the local device,
deliver the whiteboard application session to the local device, and
automatically deliver the whiteboard application session to the local interactive system for real-time collaborative editing by the user.

2. The collaborative content system of claim 1, wherein the local device comprises a video conferencing application, and wherein the request for the whiteboard application session from the user is provided to the collaborative application backend system via the video conferencing application.

3. The collaborative content system of claim 2, wherein the whiteboard application session is delivered to the user via the video conferencing application.

4. The collaborative content system of claim 2, wherein the whiteboard application session is one of Microsoft Teams, Google Meet, Zoom.

5. The collaborative content system of claim 2, wherein the whiteboard application session is requested using the video conferencing application.

6. The collaborative content system of claim 5, wherein the whiteboard application session is a digital white board.

7. The collaborative content system of claim 6, wherein the local device and local interactive system are both arranged in room (200).

8. The collaborative content system of claim 7, wherein the local device is a video conferencing display.

9. The collaborative content system of claim 8, wherein the local interactive system comprises an interactive touchscreen configured to enable the user to interact with the whiteboard application session.

10. The collaborative content system of claim 9, wherein the user is a plurality of people.

11. A collaborative content system, comprising:
a local device running a video conferencing application,
a local interactive system running an instance of a video conferencing application,
a video conferencing backend system configured to:
provide a video conferencing session to video conferencing application,
receive a request for a whiteboard application session from a video conferencing application,
provide the request for the whiteboard application session to collaborative application backend system, and
the collaborative application backend system configured to:
generate the whiteboard application session,
provide the whiteboard application session to the video conferencing backend system, and
provide the whiteboard application session to the whiteboard application for real-time collaborative editing by the user.

12. A method, comprising:
running a video conferencing application on a local device,
running a whiteboard application on a local interactive system,
operating a video conferencing backend system to:
provide a video conferencing session to video conferencing application,
receive a request for a whiteboard application session from a video conferencing application,
provide the request for the whiteboard application session to collaborative application backend system,
operating a collaborative application backend system configured to:
generate the whiteboard application session,
provide the whiteboard application session to the video conferencing backend system,
provide the whiteboard application session to the whiteboard application for real-time collaborative editing by the user.

13. A method for providing a whiteboard application session to a video conferencing session, the method comprising:
a video conferencing application connecting to a video conferencing session, the video conferencing session displayed on local display in a first location via a logical user;
a whiteboard application session being initiated via the video conferencing application;
a meeting bot configured to recognised logical user and to open whiteboard application session on a local interactive system, also at the first location.

14. The method of claim 13, wherein the video conferencing application requests the whiteboard application session from a video conferencing backend system.

15. The method of claim 14, wherein the video conferencing backend system requests the whiteboard application session from a collaborative application backend system.

16. The method of claim 15, wherein the collaborative application backend system provides the whiteboard application session to the video conferencing backend system.

17. The method of claim 16, wherein the video conferencing backend system provides the whiteboard application session to the video conferencing session.

18. The method of claim 17, further comprising:
the collaborative application backend system sending a request to video conferencing backend system to add a meeting bot into the meeting; and
the meeting bot receiving updates from the video conferencing backend system whenever a user joins or leaves the meeting; and
the meeting bot requesting the collaborative application backend system to open whiteboard application session on local interactive system when logical user is recognised by meeting bot.
